(19) United States
(12) Patent Application Publication
(10) Pub. No.: US 2026/0301329 A1
(43) Pub. Date: Oct. 1, 2026

(54) TECHNIQUES FOR INTERACTING WITH UNKNOWN OBJECTS IN EXTENDED REALITY (XR) ENVIRONMENTS

(71) Applicant: QUALCOMM Incorporated, San Diego, CA (US)

(72) Inventors: Robert Peter VIEHAUSER, Bad Hofgastein (AT); Markus EDER, Salzburg (AT); Markus Stefan BIRKNER, Bayerisch Gmain (DE); Horia-Mihai BUJANCA, Salzburg (AT)

(21) Appl. No.: 19/091,602

(22) Filed: Mar. 26, 2025

(51) Int. Cl. G06T 19/00; G06F 3/01; G06F 40/284

(52) U.S. Cl. CPC G06T 19/006; G06F 3/013; G06F 40/284

(57) ABSTRACT

The present disclosure provides techniques for leveraging language models in extended reality (XR) environments. A method may include obtaining: first user input associated with a domain and an object; second user input corresponding to a first spatial location on the object, the second user input associated with first coordinates in a world coordinate system; and object state information for the object comprising second coordinates in a local object coordinate system associated with the object; transforming the first coordinates to third coordinates in the local object coordinate system; identifying, based on the third coordinates, fourth coordinates that represent the first spatial location on the object in the local object coordinate system; obtaining an association between the first user input and the fourth coordinates; and generating, with a language model, an output based on the first user input, the first association, and context associated with the domain.

### INTRODUCTION

### Field of the Disclosure

Aspects of the present disclosure relate to techniques for leveraging language models in extended reality (XR) environments.

### Description of Related Art

Extended reality (XR) is an umbrella term encompassing immersive technologies such as virtual reality (VR), augmented reality (AR), and mixed reality (MR). XR creates either fully virtual, immersive environments or blends those virtual landscapes and features with the “real” world to enhance user experiences in a wide range of contexts (e.g., gaming, healthcare, manufacturing, education, retail, etc.). For example, AR augments the real world of a user by enabling interaction with a virtual world and/or virtual content. VR places a user inside a virtual environment generated by a computer. Further, MR merges the real and virtual worlds. With high levels of interactivity and immersion, XR helps to deliver engaging, untethered virtual experiences to users. XR virtual experiences may help to enable the creation of immersive training environments, allow for remote collaboration, offer alternative interaction methods, and provide realistic simulations, among other use cases, thereby making XR technology valuable across various industries.

In parallel, language models, such as large language models (LLMs), have revolutionized the field of natural language processing (NLP), demonstrating advanced text comprehension and generation capabilities, as well as the ability to integrate complex contextual information. For example, a language model is a type of machine learning (ML) model trained on large amounts of raw text, making it capable of understanding typical human speech or written content and responding to it by, in some cases, generating human-understandable responses through natural language generation (NLG). Language models may thus have the ability to assist in automating tasks, analyzing data, and improving customer experience, thereby making them a transformative force in many industries.

In some cases, combining language model(s) with XR technology offers the potential for creating enhanced XR applications with improved user interaction and application responsiveness. For example, language model(s) integrated into an XR application may allow for more natural and intuitive user interaction with an XR environment (e.g., via the use of spoken, natural language commands), the generation of dynamic and engaging content for XR application users, and/or help to facilitate complex tasks, such as through natural language understanding.

### SUMMARY

Certain aspects provide a method for context generation by an apparatus. The method includes obtaining during a first time period: first user input for a first domain, the first user input associated with at least a first object; second user input corresponding to a spatial location on the first object, the second user input associated with a first set of coordinates in a world coordinate system; and object state information for the first object, the object state information comprising a second set of coordinates in a local object coordinate system of the first object; transforming, based on a pose between the world coordinate system and the local object coordinate system, the first set of coordinates that represent the second user input in the world coordinate system to a third set of coordinates in the local object coordinate system; identifying, based on the third set of coordinates that represent the second user input in the local object coordinate system, a fourth set of coordinates that represent the spatial location on the first object in the local object coordinate system; obtaining an association between the first user input and the fourth set of coordinates; and generating, with a language model, context for the first domain based on the first user input and the association.

Certain aspects provide a method for output generation by an apparatus. The method includes obtaining during a first time period: first user input for a first domain, the first user input associated with at least a first object; second user input corresponding to a first spatial location on the first object, the second user input associated with a first set of coordinates in a world coordinate system; and first object state information for the first object, the first object state information comprising a second set of coordinates in a local object coordinate system associated with the first object; transforming, based on a first pose between the world coordinate system and the local object coordinate system, the first set of coordinates that represent the second user input in the world coordinate system to a third set of coordinates in the local object coordinate system; identifying, based on the third set of coordinates that represent the second user input in the local object coordinate system, a fourth set of coordinates that represent the first spatial location on the first object in the local object coordinate system; obtaining a first association between the first user input and the fourth set of coordinates; and generating, with a language model, an output based on the first user input, the first association, and context associated with the first domain.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system that provides an extended reality (XR) experience to a user.

FIG. 2 depicts example performance of language models on XR devices.

FIG. 3A depicts an example system for context generation.

FIG. 3B depicts example coordinate systems used by the system depicted in FIG. 3A.

FIG. 4A depicts an example system for output generation related to unknown objects in an XR environment.

FIG. 4B depicts example output generated by the XR system depicted and described with respect to FIG. 4A.

FIG. 5 depicts an example artificial intelligence (AI) architecture.

FIG. 6 depicts an example artificial neural network (ANN).

FIG. 7 depicts an example method for context generation.

FIG. 8 depicts an example method for natural language interaction with objects in an XR environment.

FIG. 9 depicts aspects of an example apparatus.

### DETAILED DESCRIPTION

Aspects of the present disclosure provide apparatuses, methods, processing systems, and computer-readable mediums for equipping a language model (e.g., such as a general-purpose language model, also commonly referred to as an “off-the-shelf language model”) with knowledge (referred to herein as “context”) about “unknown objects” in an XR environment. Providing this context to the language model may help to enable and/or improve the interaction, by users of XR technology that implements the language model, with such objects in the XR environment. For example, in some cases, the language model may use this context to provide more accurate and comprehensive responses to queries (e.g., from XR users) requesting information about one or more of the unknown objects. As used herein, an “unknown object” may refer to an object that is underrepresented in training data used to train the language model and/or an object that has not been encountered by the language model during training. Example unknown objects may include confidential, proprietary, and/or highly specialized products and/or technologies, for which information in publicly-available datasets (e.g., which are used to train the language model) is missing and/or inadequate.

XR interaction refers to the way users interact with virtual or augmented environments during XR experiences. Specifically, in XR, users may interact with objects through various methods, including via direct manipulation (e.g., physically grabbing, moving, rotating, etc.), gesture-based controls (e.g., using hand, body, or facial movements), and/or eye gaze (e.g., directing one's eyes towards an object to act as a pointer towards the object). Additionally, in some cases, XR interaction may include natural language interaction where a user interacts with virtual or augmented environments via voice commands and/or text-based queries posed in natural language. Rather than relying on traditional inputs (e.g., via the use of keyboards, controllers, mice, etc.), users may utilize natural language interaction to trigger one or more actions, manipulate object(s), navigate or move around in an XR environment, and/or ask questions and receive information about object(s), such as during an XR experience. Thus, natural language interaction, when supported in XR, may help to provide a more intuitive and immersive experience for users, such as by mimicking real-world communication, enabling more natural interaction, and reducing the need for cumbersome interfaces.

As an illustrative example, a user desiring to obtain information about an object in an XR environment may have traditionally used a controller to “right-click,” or perform some equivalent predefined action, to display information about the object. For example, the user-initiated action may cause a context menu to appear in a user interface of an XR device of the user, such that the user is able to learn about the object. While this type of interaction enables the user to obtain the desired information, this type of interaction may feel unnatural to the user. That is, in the real-world, the user may learn about an object through conversation, observation, touch, and/or other senses, not based on some physical selection of the object. To more closely mimic this real-world behavior and thus, provide a more natural and intuitive user experience, some XR systems may be implemented with technology that enables them to process and respond to natural language interaction of a user. For example, instead of “right-clicking” on the object in the XR environment, the user may point to the object and ask questions like “What is this object? or “What does this object do?” An XR system capable of handling natural language interaction may process the user's query to understand its context, sentiments, and/or intent and thereby generate a contextually appropriate and accurate response, which may be provided to the user as output. In certain aspects, the response may include similar information as the information displayed to the user in the contextual window associated with the object (e.g., when the user “right-clicks” on the object). In this way, the user may learn similar information about the object, but in a more natural way, such as via dialogue between the user and the XR system.

Some XR systems enable intuitive and natural language interactions with objects by leveraging language models (e.g., such as LLMs). For example, language models may be combined with XR technology to understand user's intent and/or context, thereby allowing for actions such as information retrieval, content generation, objection manipulation, and/or the like via voice commands and/or natural language queries. For example, with respect to performing information retrieval and/or content generation tasks in XR systems, a language model may use its learned representations of language (e.g., learned embeddings, where “embeddings” are numerical representations given to text in a vector space, capturing the semantics and meaning of such text) to understand the context and meaning of a user-provided query, and thereby produce a coherent and relevant response. The generated response may include information about an object in the XR environment that the user in inquiring about via the user-provided query. In some cases, the language model may additionally process contextual data (e.g., information that provides additional context, background, or situational details about the object, the environment, or the user), such as a user's location within an XR environment, eye gaze, and/or gesture(s) of the user, in addition to the user's natural language input to generate a more accurate response.

Although language models are capable of assimilating a vast amount of knowledge, such as to perform NLP tasks, and thus provide a solution for enhancing XR experiences, these models are not without limitations. For example, while a powerful tool, the performance and/or capability of a general-purpose language model may be fundamentally limited by the quantity and/or quality of the underlying, publicly-available training data used to pre-train the model. Thus, specific knowledge that is not included in this training data (e.g., due to this knowledge being underrepresented and/or inaccurately represented in the training data), yet is needed for the model to accurately respond to a user-provided query, may present a technical problem. For example, the lack of this specific knowledge base may lead to the general-purpose language model generating an incomplete and/or inaccurate response to the user-provided query.

Example knowledge often not encoded in a language model's training data may include domain-specific knowledge (also commonly referred to as “domain knowledge”), which refers to expertise and understanding within a particular field, area of study, or subject matter (referred to herein as a “domain”). For example, publicly available, massive datasets of text, which are used to pre-train a general-purpose language model, may not include confidential, specialized, and/or complex knowledge artifacts; thus, a language model may lack an ability to generate accurate, complete, and relevant responses to queries related to such knowledge. As an illustrative example, a language model asked to provide proper assistance with respect to the use of specialized machinery developed internally for a company (e.g., via user queries asking for details related to using the machinery, its special components, and/or the like) may be unable to provide the requested assistance, at least due to the training data used to train the language model lacking information about this machinery. The training data may exclude information about this machinery at least due to the machinery being confidential, highly-specialized, and proprietary to the company.

To address the aforementioned shortcomings of language models, some approaches seek to re-train or fine-tune language models on new, updated, and/or specialized knowledge bases that include the previously missing knowledge artifacts. As used herein, “fine-tuning” refers to a process for adapting parameters of a pre-trained language model for a specific task and/or domain. For example, with respect to the previous example, re-training and/or fine-tuning techniques may be applied to the language model such that the model learns the knowledge and representations associated with the specific machinery. Though re-training and/or fine-tuning may be useful for improving the utility and effectiveness of language models for particular domains, re-training and/or fine-tuning techniques often require a significant amount of time and compute resources, and, in some cases, may create an inherent latency with respect to deploying updated language models for use (e.g., such as in XR applications). Furthermore, in some cases, only a small number of general-purpose language models may allow for fine-tuning, at least due to their licensing models prohibiting custom adoption by third-party companies. Additionally, in some cases, it may be impractical to maintain, and deploy on user devices, language models re-trained and/or fine-tuned for specific use cases (e.g., to each perform a specific task), especially in scenarios where a single user device serves multiple instances and/or scenarios.

As such, alternative techniques for equipping language models with domain-specific knowledge may be desired. In some cases, such techniques may be desired for improving the performance of XR technology implementing a language model, such as by equipping the language model with context about one or more unknown objects in an XR environment to enable the language model to provide more comprehensive and accurate responses/output to queries about such objects.

Certain aspects described herein overcome the aforementioned technical problems and provide a technical benefit to the field of XR. Specifically, certain aspects described herein provide an XR system implementing a language model, an object tracker, and a tracker (e.g., such as a multimodal tracker, in some cases) that is used to monitor hand movement, eye movement, and/or eye gaze of a user and/or movement of an XR controller by the user. The integration of the language model in the XR system helps to provide a more immersive experience for users, such as by enabling intuitive and natural language interactions with objects during an XR experience offered by the XR system.

In certain aspects, the XR system may be configured to process and respond to user queries (e.g., posed in natural language) associated with an object in a scene. For example, the XR system may obtain, as first user input, a natural language query requesting information about the object, and, as second user input, contextual data for the first user input. The second user input may include hand movement, eye movement, eye gaze, etc. of the user that is detected by the tracker and corresponds to a spatial location on the object referenced in the first user input. The second user input may be defined based on first coordinates in a tracker coordinate system associated with the tracker. To identify the spatial location on the object that the user is inquiring about, the XR system may further obtain object state information, including at least position information (e.g., coordinates) and pose information for the object in a local object coordinate system associated with the object. The XR system may identify the spatial location on the object based on transforming the first coordinates of the second user input in the tracker coordinate system to second coordinates in the local object coordinate system associated with the first object, and further identify the spatial location on the object as a point on the object that is associated with (e.g., intersects with) the second coordinates that represent the second user input (e.g., this “point” may refer to a point on the object that the user is pointing at, looking at, gazing towards, etc.). The point may be defined by third coordinates in the location object coordinate system. The XR system may generate an association between the second user input and the third coordinates representing the spatial location (or point) on the object and further process this association with the first user input to generate output in response to the natural language query. Processing the association in addition to the first user input may provide the language model with sufficient information to identify the spatial location on the object that the first user input is associated with such that the language model is able to provide an accurate response.

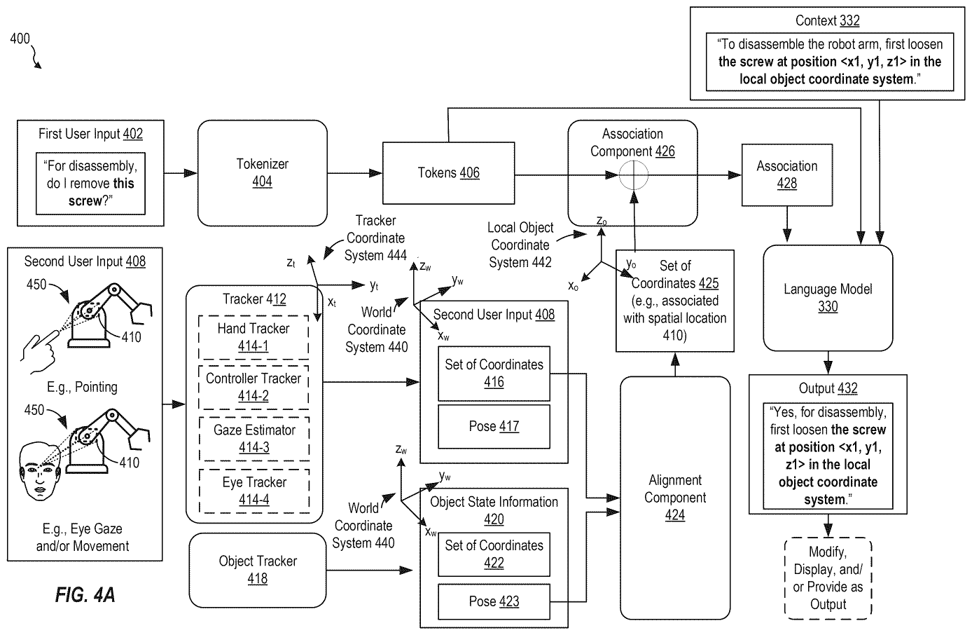

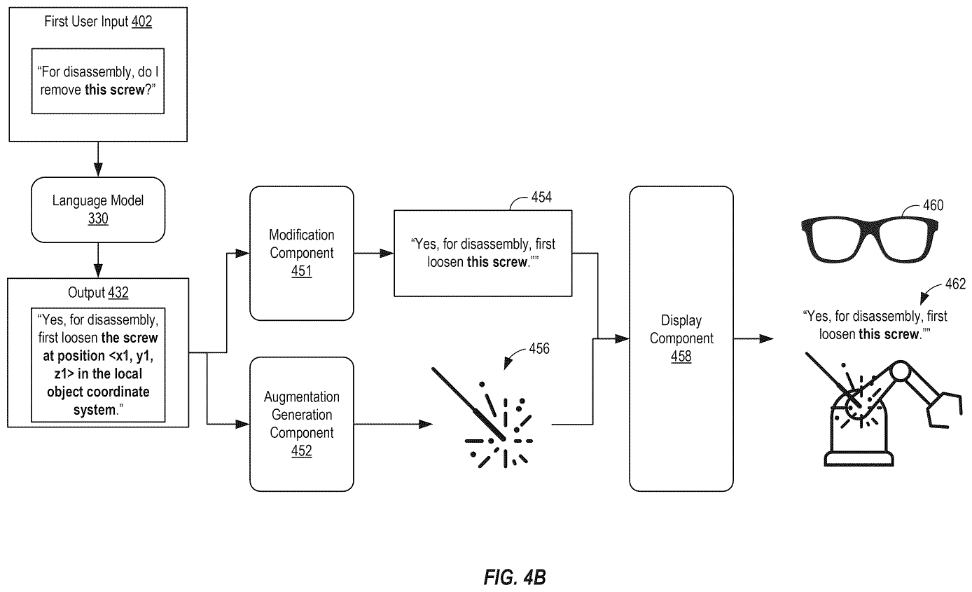

In certain aspects, first user input obtained by the language model may reference an object in the scene that is “unknown” to the language model. For example, the object referenced in the first user input may be associated with a domain for which the language model lacks expertise and understanding. Thus, to enable the language model to generate output that accurately and sufficiently responds to the first user input, the language model may further process context associated with the domain. In certain aspects, the context processed by the language model be obtained from a context window associated with the language model. Processing, by a language model, example context associated with a domain is depicted and described below with respect to FIG. 4A.

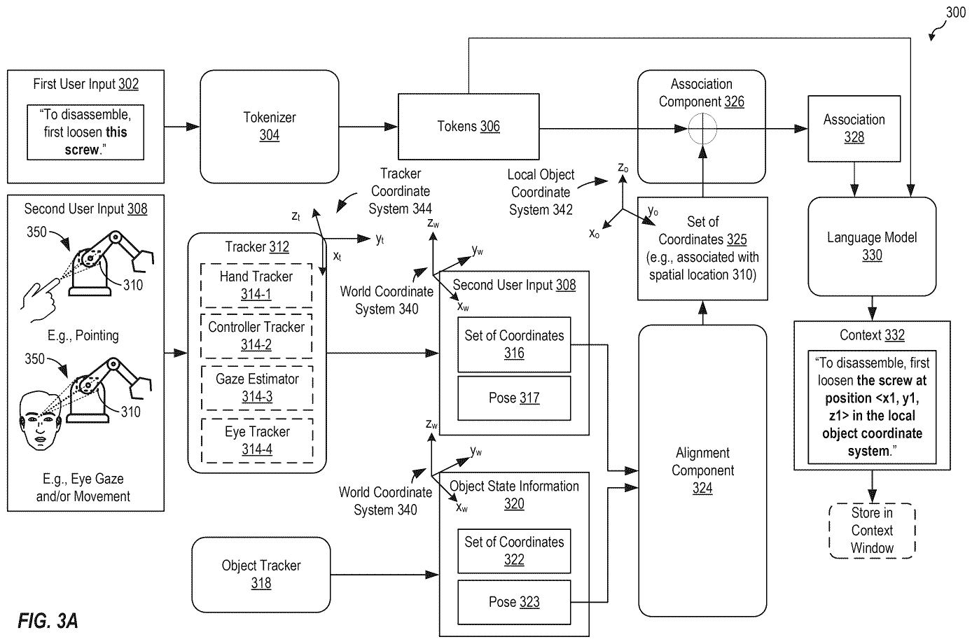

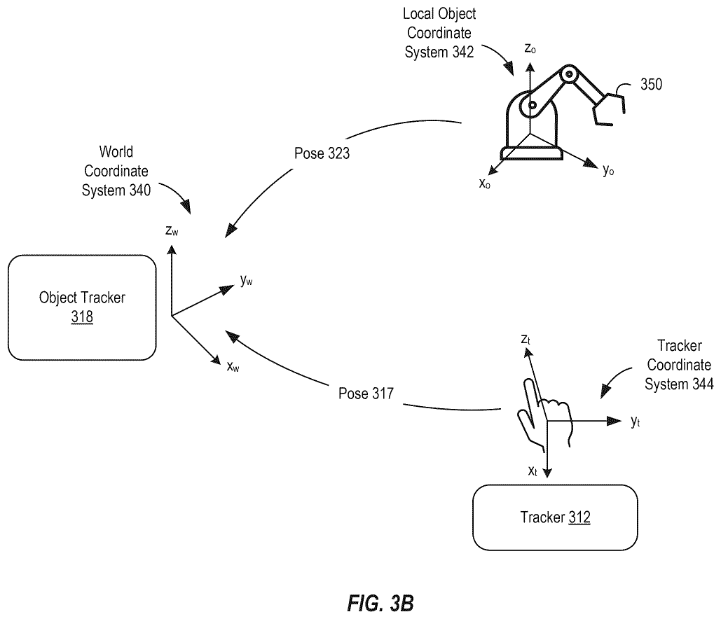

In certain aspects, the context processed by the language model may be pre-defined and added to the context window of the language model prior to the model generating the output for the first user input (e.g., in response to the natural language query). For example, the XR system may obtain, as other first user input, domain knowledge about an object in a scene (e.g., where the object is associated with the domain, such as a special component of some machinery that is proprietary to a company), and, as other second user input, contextual data for the first user input (e.g., corresponding to a spatial location on the object referenced in the first user input). To identify the specific spatial location on the object that the user has provided information about, the XR system may further obtain object state information, including at least spatial information, for objects in the scene. The second user input may be defined based on first coordinates in a tracker coordinate system associated with a tracker that detects the second user input (e.g., an eye gaze tracker, a hand tracker, etc.). The XR system may identify the specific spatial location on the object based on transforming the first coordinates of the second user input in the tracker coordinate system to second coordinates in the local object coordinate system associated with the first object, and further identify the spatial location on the object as a point on the object that is associated with (e.g., intersects with) the second coordinates representing the second user input (e.g., this “point” may refer to a point on the object that the user is pointing at, looking at, gazing towards, etc.). The point may be defined by third coordinates in the location object coordinate system. The XR system may generate an association between the second user input and the third coordinates representing the spatial location (or point) on the object to generate context associated with the domain. This context may be stored in the context window of the language model, and as described above, used during inferencing (e.g., when responding to user queries for the domain). Example generation of context associated with a domain is depicted and described below with respect to FIG. 3A.

The XR system and techniques for (1) context generation and (2) domain-specific output generation (e.g., based on context included in a context window of a language model) described herein may provide various beneficial technical effects and/or advantages, including an ability to adapt to new domains without the use of re-training and/or fine-tuning techniques. For example, processing, by the language model, context associated with a particular domain helps to adapt a language model to the domain such that the language model is able to generate contextually accurate output for the domain. Furthermore, this adaptation may occur without the utilization of re-training and/or fine-tuning techniques, thereby reducing the resource overhead generally associated with performing these tasks to traditionally adapt the language model. Additionally, the context used for domain-specific output generation and stored in the context window of the language model may be stored with a relatively low memory footprint, thereby further reducing the resource usage associated with the use of the context for inferencing.

This adaptation may also occur for different domains. As such, the language model may be enabled to quickly and flexibly adapt to different domains such that it offers a solution useful for carrying out various tasks, including, for example, information retrieval, content generation, and/or object manipulation, for various objects in various XR environments.

### Aspects Related to XR

As described herein, XR is the umbrella term for technologies that act as interfaces between the real (e.g., physical) and virtual worlds. For example, XR technologies can combine physical environments from the real world and virtual environments or content to provide a user with an XR experience. An XR experience may allow the user to interact with a real or physical environment enhanced and/or augmented with virtual content. As another example, an XR experience may allow a user to interact with a completely virtual environment. The term XR may encompass VR, MR, and AR technologies. Each of these forms of XR may offer a different level of immersion and/or interaction to allow users to experience and/or interact with immersive virtual environments and/or content.

For example, VR may completely immerse a user in a virtual world, usually using a head-mounted display (HMD) and/or projections that encapsulate the user with a full visual experience of a virtual world. By tracking the motions and position of the user, the motions and position of the user may be mimicked in the virtual world giving the perception of full immersion.

AR, on the other hand, is the integration of digital information with a user's physical environment in real time. Unlike VR, which creates a completely artificial environment for the user, AR may enable a user to experience a real-world environment with generated perceptual information overlaid on top of it. AR delivers visual elements, sound, and/or other sensory information to the user through a device, such as a smartphone, smart glasses, and/or an AR headset. In certain aspects, AR is used to generate digital content that may be added to a real-world environment. The digital content may be overlaid onto the device to create an interwoven and immersive experience where the digital content alters the user's perception of the physical world. For example, the overlaid perception information may be added to and/or mask part of a physical environment.

While VR immerses users in a simulated three-dimensional (3D) environment, and AR layers elements of a virtual world on real-world surroundings, MR combines the two to create an experience where users can interact with both the virtual and physical worlds more seamlessly. For example, combining aspects of VR and AR allows for objects and/or actions from the real world to affect simulated objects in an MR environment.

The use of XR technology is often associated with industries such as gaming and/or entertainment. However, XR technology has also been implemented to enhance user experiences in a wide range of contexts, such as healthcare, education, and/or retail, to name a few. For example, XR may be used to teach workers how to assemble doors for airplanes, let medical students practice in an operating room setting, and/or allow for virtual try-ons in retail to enable more informed purchases, among many other use cases.

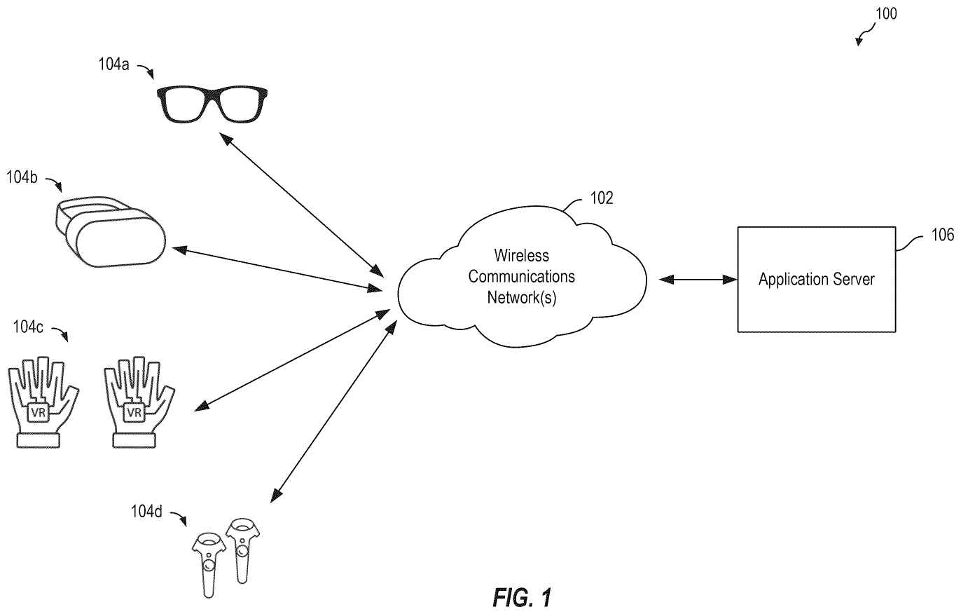

FIG. 1 depicts an example system 100 that may provide an XR experience to one or more users. As shown, system 100 includes XR devices 104a-d, an application server 106, and wireless communications network(s) 102.

The XR devices 104a-d may be or include XR glasses 104a, an XR headset 104b, XR gloves 104c, XR controllers 104d, one or more sensors (not shown), an XR BS (not shown), and/or one or more other devices. The XR devices 104a-d may be configured to engage in communications of a service, such as XR traffic. The XR devices 104a-d may be an example of one or more UEs that communicate the traffic (e.g., such as multi-modal traffic) of one or more users. In some cases, one or more of the XR devices 104a-d may communicate traffic of a single user.

In this example, the XR devices 104a-d may communicate with an application server 106 via wireless communications network(s) 102. The application server 106 may be or include an XR application server that hosts certain XR content for the XR devices 104a-d. The application server 106 may be or include one or more computing devices including, for example, a server, a computer (e.g., a laptop computer, a tablet computer, a personal computer (PC), a desktop computer, etc.), a virtual device, or any other electronic device or computing system capable of hosting one or more XR sessions.

The traffic may include various traffic streams associated with a service (e.g., an XR session) including, for example, pose traffic, control traffic, sensor traffic, haptic traffic, video traffic, and/or audio traffic. As an example of some traffic involved in cloud-based AR rendering, the application server 106 may obtain video frames captured at the XR headset 104b along with pose information and/or control information. The application server 106 may overlay (or determine where to overlay) computer generated content in the video frames, such as textual information or computer-generated visualizations. The application server 106 may send, to the XR headset 104b, the augmented video frames and/or information to render the augmented video frames at the XR headset 104b. In some cases, the application server 106 may send other traffic streams to the XR devices 104a-d, such as audio traffic, haptic feedback information, etc.

Wireless communications network(s) 102 may facilitate communications and/or data exchanges between different system components and the different entities associated with system 100, including between at least XR devices 104a-d and application server 106. The wireless communications network(s) 102 may include a wireless local area network (WLAN), a wireless personal area network (WPAN), a wireless wide area network (WWAN), or the like.

A WLAN is a type of local area network (LAN) that connects local network nodes using radio technology rather than wired connection. A WLAN may include a wireless network configured for communications according to an Institute of Electrical and Electronics Engineers (IEEE) standard such as one or more of the 802.11 standards, etc. For example, WiFi, which refers to a suite of wireless communication protocols defined by IEEE 802.11 (e.g., IEEE 802.11ac and 802.11ax), is one type of WLAN. WiFi operates on the 2.4 GHz and 5 GHz frequency bands and is widely used for local area networking and internet access. WiFi is commonly found in homes, businesses, and public spaces, providing wireless connectivity for a wide range of devices such as smartphones, laptops, and smart home devices, for example.

WiGig, which is defined by the IEEE 802.11ad wireless networking standard, is another type of WLAN. WiGig is a wireless technology that operates on the 60 GHz frequency band and provides high-speed wireless communication over short distances. WiGig is designed to complement and extend the capabilities of traditional WiFi by offering multi-gigabit data rates for applications such as XR.

A WPAN is a small-scale wireless network that requires little or no infrastructure and operates within a short range. A WPAN may be created using Bluetooth, infrared, Z-wave, or any similar wireless technologies. For example, Bluetooth is a wireless technology that allows devices to communicate over short distances (e.g., up to 10 meters (m)) using low-power radio waves. Bluetooth enables short-range data and voice communication between devices, such as smartphones, headphones, speakers, laptops, printers, and/or medical equipment, among others. Bluetooth operates in the 2.4 GHz unlicensed industrial, scientific, and medical (ISM) frequency band, which helps to provide a good balance between range and throughput.

While WLAN and WPAN primarily use Wi-Fi and Bluetooth technology, respectively, a WWAN uses cellular technology. For example, a WWAN may include an NR system (e.g., a 5G NR network), an E-UTRA system (e.g., a 4G network), a UMTS (e.g., a Second Generation (2G) or Third Generation (3G) network), a code division multiple access (CDMA) system (e.g., a 2G/3G network), any future WWAN system, or any combination thereof.

XR devices 104a-d connected to wireless communications network(s) 102 may communicate among each other, with application server 106, and/or with any of various wireless devices via any of various radio access technologies (RATs), where a wireless device may refer to a wireless communications device. The RATs may include, for example, WWAN communications (e.g., E-UTRA and/or 5G NR), WLAN communications (e.g., IEEE 802.11), WPAN communications (e.g., short-range communications, such as Bluetooth), non-terrestrial network (NTN) communications, etc. The wireless devices may include, for example, UEs, network entities, wireless APs, wireless STAs, Bluetooth-enabled devices, and/or the like. The wireless devices may also include midhaul and/or backhaul network elements such as, intermediary RAN elements, operator/cloud network elements, WLAN controllers, and/or the like.

As an illustrative example, XR glasses 104a may be capable of connecting to the Internet via WiFi, a cellular service provider, and/or Bluetooth. Wi-Fi works by connecting XR glasses 104a to a wireless router (e.g., a wireless AP), which then connects to the Internet. A cellular connection enables XR glasses 104a to connect to the Internet by accessing BSs that provide communications coverage in different cells. Bluetooth enables XR glasses 104a to connect to wireless devices through a process referred to as “pairing,” which is a form of information registration for linking wireless devices. XR glasses 104a may switch between WiFi, cellular, and Bluetooth communications to communicate XR traffic with any of various wireless devices.

As discussed herein, in certain aspects, language models may be leveraged by XR technology (e.g., XR devices and/or systems) to enable intuitive and natural language interactions with objects in an XR environment. For example, language model(s) may be combined with XR technology to understand a user's intent and context, thereby allowing for actions like information retrieval, content generation, objection manipulation, and/or the like via voice commands and/or natural language queries.

While a powerful tool, the performance and/or capability of a language model (e.g., such as a general-purpose language model) may be fundamentally limited by the quantity and/or quality of the underlying training data used to pre-train the model. Thus, specific knowledge that is not included in this training data (e.g., due to this knowledge being underrepresented and/or inaccurately represented in the training data), yet is needed for the model to carry out tasks such as information retrieval and/or object manipulation for objects in an XR environment, may present a technical problem. That is, the language model, without this information, may be unable to carry out such tasks, including, for example, generating contextually accurate and complete output for the domain.

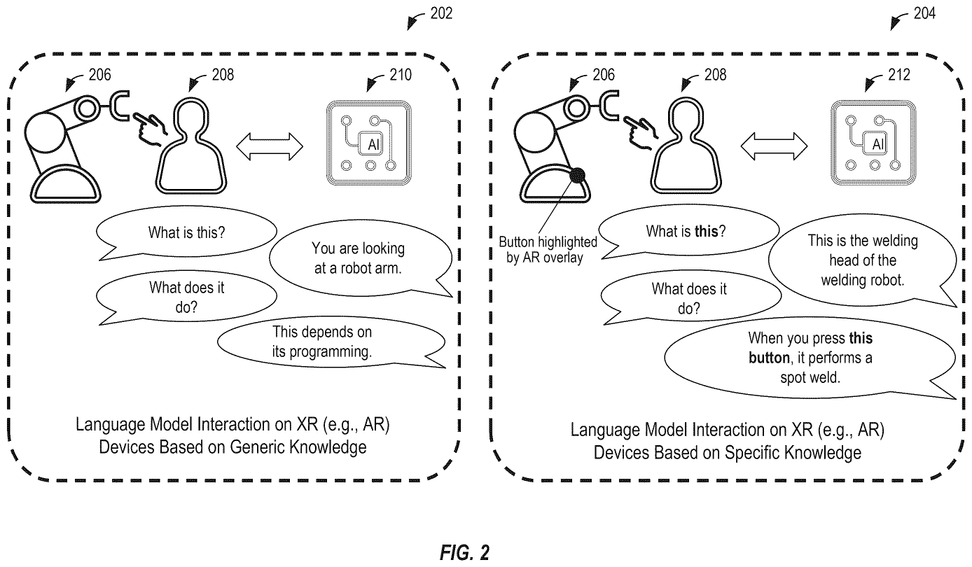

FIG. 2 depicts example performance of language models integrated with XR technology and used to process and respond to user queries (e.g., from a user 208) associated with an XR environment. In a first example case, as shown at 202, a language model 210 may comprise a general-purpose language model trained on publicly available training data. Further, in a second example case shown at 204, a language model 212 may comprise a language model fine-tuned for a first domain. In each case, the language model 210, 212 may be prompted to provide output in response to natural language queries from user 208 about a same object 206 associated with the first domain (e.g., including “What is this?” and “What does it do?”). Further, when prompting the language model 210, 212 the user 208 may additionally point to object 206 in the XR environment.

For the general-purpose language model 210, the object 206 (e.g., referenced in the user input), may represent an “unknown object,” or an object in the XR environment that is associated with a domain that the model has inadequate understanding and/or knowledge about. For the fine-tuned language model 212, however, the object 206 (e.g., referenced in the user input), may represent a “known object,” or an object in the XR environment that is associated with the first domain (e.g., the domain for which the language model 212 is fine-tuned).

As shown at 202, in response to receiving the input from user 208, the general-purpose language model 210 may generate output responses including, for example, “You are looking at a robot arm” and “This depends on its programming.” Because the general-purpose language model 210 lacks specific information about the object 206, the output responses generated by the general-purpose language model 210 may be generic and provide minimal detail. Alternatively, as shown at 204, in response to receiving the input from user 208, the fine-tuned language model 212, may generate output responses of “This is the welding head of the welding robot” and “When you press this button, it performs a spot weld,” as well as digital content overlaid over a button of object 206 via a user interface.

Although the output generated by general-purpose language model 210 at 202 may not be, per se, inaccurate, the output may fail to provide the same level of detail as the output produced by fine-tuned language model 212 at 204. For example, the output produced by fine-tuned language model 212 may provide more contextually accurate and complete responses to the natural language queries from user 208 than the output generated by general-purpose language model 210. This may be the case, at least, due to the fact that the fine-tuned language model 212 is trained on training data for the first domain (e.g., the domain associated with the object 206 that user 208 inquired about).

For at least this reason, it may be beneficial to fine-tune (or re-train) a language model for a specific domain prior to integration of the language model with XR technology. This fine-tuning (or re-training) may equip the language model with domain-specific knowledge, such that the language model is capable and/or better able to perform domain-specific tasks when leveraged by XR devices and/or systems, for example, to generate output in response to natural language queries about one or more objects in an XR environment that are associated with a particular domain.

Though re-training and/or fine-tuning may be useful for improving the utility and effectiveness of language models for particular domains, such as when these models are integrated with XR technology, re-training and/or fine-tuning techniques may require a significant amount of time and compute resources. Further, in some cases, re-training and/or fine-tuning techniques may create an inherent latency with respect to deploying updated language models for use (e.g., such as in XR applications). As such, alternative techniques for equipping language models with domain-specific knowledge may be desired. In some cases, such techniques may be desired for improving the performance of XR technology implementing a language model, such as by equipping the language model with context about one or more unknown objects in an XR environment to enable the language model to provide more comprehensive and accurate responses/output to natural language queries about such objects in the XR environment.

### Aspects Related to Interacting with Unknown Objects in XR Environments

Aspects described herein improve upon the state of the art by providing techniques for equipping a language model (e.g., such as a general-purpose language model implemented in an XR system), with knowledge about “unknown objects” in an XR environment. The “unknown objects” may represent objects that are associated with a first domain for which the language model lacks expertise and understanding. For example, training data used to train the language model may exclude information for the first domain such that the language model has inadequate understanding and/or knowledge about such objects. This knowledge provided to the language model may include context for the first domain, which the language model may use when generating output related to an unknown object in the XR environment. For example, the context may be used as additional input into the language model, which may be interpreted based on the generic (e.g., lacking information for the first domain), yet vast, knowledge base on the language model. Based on processing this additional context, the language model may be capable of producing more contextually accurate and complete responses to natural language queries associated with the unknown object.

In certain aspects, the context processed by the language model may be pre-defined and added to a context window of the language model, such as prior to the model generating output in response to a natural language query. For example, the language model may load this context during a subsequent interaction session with a user, such that it may be used for inferencing. In certain aspects, the context processed by the language model may be additionally generated by the language model before being added to the context window.

Example generation of context associated with a domain is depicted and described below with respect to FIGS. 3A and 3B. Processing, by a language model, example context associated with a domain is depicted and described below with respect to FIG. 4A. Example output generated by the language model, such as based on processing the context in FIG. 4A, is depicted and described below with respect to FIG. 4B.

### Example XR System for Context Generation

FIG. 3A depicts an example XR system 300 configured for context 332 generation. As shown, XR system 300 may include a tokenizer 304, a tracker 312, an object tracker 318, an alignment component 324, an association component 326, and a language model 330 for generating context 332 for a specific domain.

Although not meant to be limiting to this particular example, in FIG. 3A, the context 332 generated by XR system 300 may be related to highly specialized and confidential machinery (e.g., the specific domain) and may include information about special components of the machinery, such as the robot arm shown at 350 in FIG. 3A. For example, XR system 300 may be used to generate context 332 that includes some instructions related to the disassembly of the robot arm, and more specifically, a particular screw of the robot arm (e.g., where the screw is associated with a specific spatial location on the robot arm). This context 332 may be generated at least based on the information included in first user input 302, which may include audio input, text input, or one or more frames associated with the particular screw and/or robot arm. This context 332 may be generated and stored in a context window of language model 330, such that it may be subsequently used when a user (e.g., during an XR experience) asks questions and/or requests information about the screw, such as shown in FIG. 4A.

To perform the context 332 generation, XR system 300 may obtain first user input 302 and second user input 308. In certain aspects, first user input 302 may include information for a specific domain, such that context 332 is generated for the specific domain. More specifically, in certain aspects, first user input 302 may include information about an object (e.g., an object in an XR environment that is unknown to language model 330, such as object 350 shown in FIG. 3A) associated with the domain, such that context 332 is generated for the object for subsequent use by language model 330. First user input 302 may include text data, audio data, and/or one or more frame, which may be provided to XR system 300 by a user. In certain aspects, first user input 302 may include a demonstrative pronoun or adjective spoken and/or entered as text by the user (e.g., “this,” “here,” “there,” etc.).

Second user input 308 may include contextual data for the first user input 302. For example, second user input 308 may include information about a position and/or an orientation of the user's hand(s), the user's eyes, etc. when hand gestures, hand movement, eye movement, eye gaze, etc. of the user are detected. In certain aspects, second user input 308 may be associated with first user input 302 based on a time period associated with first user input 302 and second user input 308 being the same (e.g., first user input 302 and second user input 308 may be obtained by XR system 300 simultaneously, for example, a user provides the first user input 302 while also pointing, moving their eyes, etc. towards a particular spatial location 310 on the object 350 referenced in the first user input 302).

In certain aspects, second user input 308 may be obtained by tracker 312 of XR system 300. Tracker 312 may comprise a hand tracker 314-1, a controller tracker 314-2, a gaze estimator 314-3, and/or an eye tracker 314-4 (among other similar tracking technology not shown in FIG. 3). For example, in certain aspects, tracker 312 may represent a multimodal tracker. Hand tracker 314-1 may refer to a technology configured to track the position, orientation, and/or velocity of a user's hands and/or fingers. In certain aspects, hand tracker 314-1 may be configured to detect hand gestures of a user, such as detect when a user is pointing at an object (e.g., the object referenced in user first user input 302) within the XR environment. Controller tracker 314-2 may refer to a technology configured to track the position and/or orientation of a controller in three-dimensional (3D) space, such as an XR controller controlled by a user of XR system 300. Gaze estimator 314-3 may refer to a technology configured to determine user gaze, or simply, predict where a user is looking, either as gaze directions or as points of regard in space (e.g., which may be associated with spatial locations on the object referenced in user first user input 302). As used herein, gaze direction of a user may refer to a vector positioned along a visual axis of the user, pointing from the fovea of the user's eye through the center of the user's pupil to a gazed-at spot/point, commonly referred to as a “fixation point.” The visual axis, also commonly referred to as the “foveal-fixation axis,” may be an imaginary line that connects the fixation point, the fovea, and the corneal center of the eye. Gaze direction may be a product of two contributing factors, including (1) head pose and (2) eye location of a user. Head pose of a user may refer to the orientation of the user's head in 3D space. Eye tracker 314-4 may refer to a technology configured to monitor and analyze eye movement of a user in real-time. For example, eye tracker 314-4 may be used to measure and record information about where a user is looking (e.g., determine a gaze point), how long the user looks in this direction (e.g., determine a fixation duration), eye lid movement of the user (e.g., such as a blinking frequency of the user, etc.), and/or a pupil size of the user, among others.

In certain aspects, tracker 312 may be associated with a tracker coordinate system 344 (e.g., a coordinate system with axes xₜ, yₜ, and zₜ). Tracker 312 may use tracker coordinate system 344 to describe and define where things are located in 3D space with respect to tracker 312. For example, in certain aspects, tracker 312 may define second user input 308 as a set of coordinates (e.g., Cartesian coordinates [x, y, z]) in the tracker coordinate system 344. In one example, the set of coordinates defining the second user input 308 in tracker coordinate system 344 may represent the position of a user's hand with respect to tracker coordinate system 344.

In certain aspects, second user input 308 may correspond to a spatial location 310 (e.g., a geographic location or volumetric space) on the object 350 referenced in first user input 302. For example, pointing by the user (e.g., represented as second user input 308 detected by hand tracker 314-1) may correspond to a spatial location 310 in the scene, indicating where the user is pointing to when first user input 302 is obtained by XR system 300. As another example, eye gaze of a user may correspond to a spatial location 310 in the scene, indicating where the user is looking at when first user input 302 is obtained by XR system 300.

In certain aspects, second user input 308 may be defined by a first set of coordinates 316 (e.g., volumetric coordinates) in a first coordinate system 340 associated with tracker 312 (e.g., coordinate system with axes x₁, y₁, and z₁).

In the example shown in FIG. 3, first user input 302 may include input “To disassemble [the robot arm], first loosen this screw.” This first user input 302 may be obtained by XR system 300 such as based on a user verbally providing this input and XR system 300 converted this speech into text. The first user input 302 may be captured by XR system 300 (and spoken by the user) during a first time period (e.g., at time T1). Second user input 308 may include (1) pointing by the user towards spatial location 310 on object 350 and (2) eye gaze of the user towards spatial location 310 on object 350, which is detected by tracker 312 during the first time period. In certain aspects, spatial location 310 may include the screw of the robot arm (e.g., the object 350) referenced in first user input 302.

In addition to obtaining first user input 302 and second user input 308, XR system 300 may further obtain object state information for the object 350 (e.g., the robot arm) referenced in first user input 302. Object state information may provide information about object 350 in the scene during the first time period (e.g., the time period when first user input 302 and second user input 308 is obtained by XR system 300). Object state information 320 may be obtained from object tracker 318 in XR system 300. For example, object tracker 318 may be configured to perform object tracking. Object tracking is a computer vision task that aims to estimate the trajectory(ies) of one or more objects of interest across successive frames. The objective of object tracking is to maintain a consistent association between an object and its representation across different frames, despite changes in position, scale, orientation, and/or appearance, including when the object temporarily disappears from view and/or becomes obscured.

Example object state information 320 obtained for object 350 may include information about a position and an orientation of the object in the scene during the first time period. The position and orientation of the object 350 may be defined by (1) a set of coordinates 322 (e.g., cartesian coordinates [x, y, z]) in a world coordinate system 340 (e.g., a reference coordinate system) (e.g., coordinate system with axes x_{w}, y_{w}, and z_{w}) associated with object tracker 318 and (2) a pose 323 between the world coordinate system 340 (e.g., object tracker 318) and an inherent coordinate system of object 350 referred to herein as a local object coordinate system 342 (e.g., a coordinate system with axes xₒ, yₒ, and zₒ which is shown in FIG. 3B). For example, object tracker 318 may detect object 350. To determine the set of coordinates 322 representing object 350 in the world coordinate system 340, object tracker 318 may first calculate pose 323 (e.g., a six degrees of freedom (6-DOF) pose,

$$“ {𝕋}_{o}^{w} ” )$$

between the local object coordinate system 342 of object 350 and world coordinate system 340. Object tracker 318 may then determine set of coordinates 322 representing object 350 in world coordinate system 340 based on pose 323 (e.g., identify where, and with what orientation, object 350 is situated in world coordinate system 340 based on using the pose 323 to transform and/or rotate coordinates of the object 350 to the frame of reference).

Other example object state information 320 associated with object 350 may include one or more visual features (e.g., an appearance) of the object 350; a velocity of the object 350; an acceleration of the object 350; a heading of the object 350; a trajectory score (e.g., a measure of the confidence associated with a predicted object trajectory, such as a confidence level) associated with the object 350; dynamic(s) of the scene; an occlusion state of the object 350 (e.g., indicating whether the object 350 is currently occluded and/or the extent of the occlusion, such as partial or full occlusion); an appearance change rate (e.g., the rate at which the appearance of the object 350 changes over time, such as due to lighting changes, deformation, etc.); scene flow information (e.g., information about the relative 3D motion of the object 350 within the scene, which may aid in understanding dynamic environments); and/or optical flow information (e.g., information about the relative 2D motion of the object 350 within the scene, which may aid in understanding dynamic environments), among other information.

In certain aspects, the set of coordinates in the tracker coordinate system 344, representing second user input 308, may also be transformed to a set of coordinates 316 in the world coordinate system 340 (e.g., associated with object tracker 318). For example, a pose 317 (e.g., a 6-DOF pose,

$$“ {𝕋}_{t}^{w} ” )$$

between the tracker coordinate system 344 and world coordinate system 340 may be calculated. This pose 317 may then be used to transform (e.g., translate and/or rotate) the set of coordinates representing second user input 308 in the tracker coordinate system 344 to set of coordinates 316 representing the second user input 308 in the world coordinate system 344.

An alignment component 324 may be configured to identify a set of coordinates 325 representing the spatial location 310, corresponding to second user input 308, in local object coordinate system 342. In certain aspects, alignment component 324 identifies set of coordinates 325 by first transforming set of coordinates 316 (e.g., representing second user input 308) in world coordinate system 340 to a corresponding set of coordinates, representing second user input 308, in local object coordinate system 342. In certain aspects, alignment component 324 performs this transformation using an inverse of pose 323 (e.g., the pose between world coordinate system 340 and local object coordinate system 342). Alignment component 324 may then identify, based on the set of coordinates that represent the second user input 308 in the local object coordinate system 342, the set of coordinates 325 that represent the spatial location 310 on object 350 in the local object coordinate system 342 (e.g., which corresponds to second user input 308, or more specifically, represents the spatial location that the user is pointing to, looking at, etc. on object 350). For example, alignment component 324 may identify a closest, or an intersection point on the surface of object 350 that corresponds to the set of coordinates that represent the second user input 308 in the local object coordinate system 342.

In certain aspects, alignment component performs this alignment (e.g., to identify set of coordinates 325 in local object coordinate system 342 that are associated with spatial location 310) based on applying one or more algorithms. In some cases, techniques such as surface hit-testing, nearest neighbor search, etc. may be used to improve the alignment.

In this example, the set of coordinates 325 may be associated with an area and/or a point on the surface of object 350 that is close to or at the position of the screw referenced in first user input 302.

The output of the alignment component 324 may include set of coordinates 325 in local object coordinate system 342 that are associated with spatial location 310 (e.g., a spatial location on object 350). This set of coordinates 325 may be used by association component 326 to generate an association 328. The association 328 may be generated to indicate that a relationship exists between first user input 302 and set of coordinates 325. More specifically, association 328 may be generated to indicate that a relationship exists between at least one token of first user input 302 and set of coordinates 325 in local object coordinate system 342.

As used herein, a “token” may refer to a unit of text that language models, such as language model 330 in FIG. 3A, process and generate. A token may represent an individual character, a word, a sub word, or even a larger linguistic unit in text, depending on the specific tokenization (e.g., segmentation of text into meaningful units to capture its semantic and syntactic structure) approach used. A token may act as a bridge between the raw text data and the numerical representation that language models are able to work with.

For example, a tokenizer 304 may tokenize first user input 302 and obtain tokens 306. Put differently, tokenizer 304 may break (e.g., partition) the text of first user input 302 into smaller pieces, referred to herein as “tokens 306.” An example token 306 generated by tokenizer 304 may include a word, a sub-word, a phrase, etc. that conveys a particular idea or concept within first user input 302. In the example depicted in FIG. 3A, tokenizer 304 may tokenize first user input 302 and obtain six tokens 306 (e.g., “To,” “disassemble,” “first,” “loosen,” “this,” and “screw”).

Association component 326 may generate an association 328 between one or more of the tokens 306 and the set of coordinates 325. For example, here, association component 326 may generate an association 328 between token “this” and the set of coordinates 325 or an association 328 between tokens “this” and “screw” and the set of coordinates 325. In this example, the association 328 that is generated by association component 326 may be generated to give meaning to the token “this” or “this screw” in first user input 302. For example, the association 328 may help to indicate to language model 330 that when the user refers to “this screw” in first user input 302, the user is referring to the set of coordinates 325 in local object coordinate system 342 (e.g., which correspond to a specific spatial location on object 350).

Language model 330 may then process first user input 302 and association 328. Processing first user input 302 and association 328 may cause language model 330 to generate context 332. Context 332 may include information from first user input 302 and set of coordinates 325 in local object coordinate system 342.

For the example shown in FIG. 3A, context 332 may include information about how to disassemble the robot arm, including instructions to loosen a screw which corresponds to the spatial location on the robot arm defined by cartesian coordinates <x1, y1, and z1> in the local object coordinate system 342.

In certain aspects, the context 332 may be stored in a context window of language model 330. Storing context 332 in the context window of language model 330 may enable language model 330, such as at a later time, to generate output in response to natural language queries from a user inquiring about the screw, without the language model 330 needing to be re-trained or fine-tuned with knowledge about the specialized machinery including the robot arm and the screw. Example use of context 332 by language model 330 to generate domain-specific output, e.g., output related to the specialized hardware, is depicted and described below with respect to FIG. 4A.

In certain aspects, the context 332 may be stored adjacent to a computer-aided design (CAD) model for object 350 and/or any other object reference.

In one example, XR system 300 may be used to generate context 332 based on a user providing a manual as first user input 302. For example, a manual, in the form of a written document, images, or even a training video may be provided as first user input 302. This manual may include information about object 350. Second user input may include a user pointing to or looking at different components referenced in the manual and indicating things like “the part described in the manual as ‘main arm’ is this arm” (e.g., while looking at the arm, pointing to the arm, etc.) (e.g., the additional context may be provided as additional first user input 302). The language model 330 may process this first user input 302 and this second user input 308 to generate context 332.

Although FIGS. 3A and 3B describe an example XR system 300 configured for context 332 generation based on first user input 302 and second user input 308, in some other examples, XR system 300 may be configured to generate context 332 based only on first user input 302 (e.g., generate context 332 without second user input 308). For example, another manual, in the form of a written document, images, or even a training video may be provided as first user input 302. This manual may include information about object 350, including different components of object 350 and their associated spatial locations (e.g., coordinates) in local object coordinate system 342. Thus, language model 330 may use this first user input 302 to generate context 332.

### Example XR System for Output Generation Related to Unknown Objects in an XR Environment

FIG. 4A depicts an example XR system 400 configured to perform output 432 generation related to unknown objects in an XR environment. As shown, similar to XR system 300 of FIG. 3A, XR system 400 may include a tokenizer 404, a tracker 412, an object tracker 418, an alignment component 424, an association component 426, and the language model 330 from XR system 300 for generating output 432 related to unknown object(s) in the XR environment.

In certain aspects, tokenizer 404, tracker 412, object tracker 418, alignment component 424, and association component 426 may each be an example of tokenizer 304, tracker 312, object tracker 318, alignment component 324, and association component 326, respectively, depicted and described above with respect to XR system 300. For example, object tracker 418 may an example of object tracker 318 such that the coordinate system 442 of object tracker 418 matches the coordinate system 342 of object tracker 318 exactly (e.g., share a same reference coordinate system). In certain aspects, a world coordinate system 440 associated with object tracker 418 may be an example of the world coordinate system 340 associated with object tracker 318 shown in FIGS. 3A and 3B. In certain aspects, a tracker coordinate system 444 associated with tracker 412 may be an example of tracker coordinate system 344 associated with tracker 312 shown in FIGS. 3A and 3B.

In certain aspects, language model 330 included in XR system 400 is associated with a context window that includes pre-defined context. For example, in certain aspects, language model 330 may include context 332 generated by XR system 300 in FIG. 3A. As described above, context 332 may include information for a domain that language model 330 has not been previously trained on. For example, context 332 may include information that was not encoded in the training data used to train language model 330.

As shown in FIG. 4A, XR system 400 may generate output 432 in response to first user input 402. First user input 402 may represent a first user query requesting information about an unknown object 450 in an XR environment where XR system 400 is implemented. The unknown object 450 associated with first user input 402 may include an object in the XR environment that is associated with a domain that language model 330 has not been previously trained on (e.g., language model 330 has no knowledge base for this unknown object). In certain aspects, the unknown object 450 is an example of the object 350 shown in FIGS. 3A and 3B (e.g., the robot arm). Thus, a local object coordinate system 442 of object 450 may be an example of the local object coordinate system 342 of object 350 shown in FIGS. 3A and 3B. First user input 402 may include text data or audio data, such as provided to XR system 400 by a user. In certain aspects, first user input 402 may include a demonstrative pronoun or adjective spoken and/or entered as text by the user (e.g., “this,” “here,” “there,” etc.).

Although not meant to be limiting to this particular example, first user input 402 shown in FIG. 4A may include a natural language query from a user asking “For disassembly, do I remove this screw?” This first user input 402 may be obtained by XR system 400, such as based on a user verbally providing this input as speech and XR system 400 converting the speech into text. The first user input 402 may be captured by XR system 400 (and spoken by the user) during a second time period (e.g., at time T2, which is later than the first time period T1 associated with context 332). “This screw” referenced in first user input 402 may refer to a spatial location 410 on object 450 in the XR environment, where, as described above, object 450 represent an object that is “unknown” to language model 330 implemented in XR system 400.

In addition to obtaining first user input 402, XR system 400 may also obtain second user input 408. Similar to second user input 308 depicted and described with respect to FIG. 3A, second user input 408 may include contextual data for the first user input 402. For example, second user input 408 may include information about a position and/or an orientation of the user's hand(s), the user's eyes, etc. when hand gestures, hand movement, eye movement, eye gaze, etc. of the user are detected. In certain aspects, second user input 408 may be associated with first user input 402 based on a time period associated with first user input 402 and second user input 408 being the same (e.g., first user input 402 and second user input 408 may be obtained by XR system 400 simultaneously, for example, a user provides the first user input 402 while also pointing, moving their eyes, etc. towards a particular spatial location 410 on the object 450 referenced in the first user input 402). In certain aspects, second user input 408 may be obtained by tracker 412 of XR system 400. Tracker 412 may comprise a hand tracker 414-1, a controller tracker 414-2, a gaze estimator 414-3, and/or an eye tracker 414-4 (among other similar tracking technology not shown in FIG. 4A). For example, in certain aspects, tracker 412 may represent a multimodal tracker.

In certain aspects, tracker 412 may be associated with tracker coordinate system 444 shown in FIG. 4A (e.g., a coordinate system with axes xₜ, yₜ, and zₜ). Tracker 412 may use tracker coordinate system 444 to describe and define where things are located in 3D space with respect to tracker 412. For example, in certain aspects, tracker 412 may define second user input 408 as a set of coordinates (e.g., Cartesian coordinates [x, y, z]) in the tracker coordinate system 444. In one example, the set of coordinates defining the second user input 408 in tracker coordinate system 444 may represent the position of a user's hand with respect to tracker coordinate system 444.

In certain aspects, second user input 408 may correspond to a spatial location 410 (e.g., a geographic location or volumetric space) on the object 450 referenced in first user input 402.

In this example, second user input 408 may include (1) pointing by the user towards spatial location 410 on object 450 and (2) eye gaze of the user towards spatial location 410 on object 450, which is detected by tracker 412 during the second time period. In certain aspects, spatial location 410 may include the screw of the robot arm (e.g., the object 450) referenced in first user input 402.

To generate output 432 in response to receiving first user input 402, the tokenizer 404, the alignment component 424, and the association component 426 may perform similar functions as the tokenizer 304, the alignment component 324, and the association component 326 depicted and described above with respect to FIG. 3A. For example, tokenizer 404 may tokenize first user input 402 and obtain tokens 406.

Alignment component 424 may identify a set of coordinates 425 representing the spatial location 410, corresponding to second user input 408, in local object coordinate system 442. In certain aspects, alignment component 424 identifies set of coordinates 425 by first transforming set of coordinates 416 (e.g., representing second user input 408) in world coordinate system 440 to a corresponding set of coordinates, representing second user input 408, in local object coordinate system 442. In certain aspects, alignment component 424 performs this transformation using an inverse of pose 423 (e.g., the pose between world coordinate system 440 and local object coordinate system 442). Alignment component 424 may then identify, based on the set of coordinates that represent the second user input 408 in the local object coordinate system 442, the set of coordinates 425 that represent the spatial location 410 on object 450 in the local object coordinate system 442 (e.g., which corresponds to second user input 408, or more specifically, represents the spatial location that the user is pointing to, looking at, etc. on object 450). For example, alignment component 424 may identify a closest, or an intersection point on the surface of object 450 that corresponds to the set of coordinates that represent the second user input 408 in the local object coordinate system 442. This may depend on the nature of the second user input, such as if a highlighting gesture of a user is a distinct 3D point or a ray.

The output of the alignment component 424 may include set of coordinates 425 in local object coordinate system 442 that are associated with spatial location 410 (e.g., a spatial location on object 450). In this example, the set of coordinates 425 may be associated with an area and/or a point on the surface of object 450 that is close to or at the position of the screw referenced in first user input 402.

Association component 426 may generate an association 428 between one or more of the tokens 406 and the set of coordinates 425. For example, here, association component 426 may generate an association 428 between token “this” and the set of coordinates 425 representing the screw in local object coordinate system 442 or an association 428 between tokens “this” and “screw” and set of coordinates 425 representing the screw in local object coordinate system 442.

Language model 330 may then process first user input 402, association 428, and context 332. Processing first user input 402, association 428, and context 332 may cause language model 330 to generate output 432. Output 432 may be generated to respond to first user input 402. For example, as shown in the example depicted in FIG. 4A, output 432 may include instructions related to disassembling the robot arm which include loosening the screw at position <x1, y1, z1> in the local object coordinate system 442. Output 432 may include the set of coordinates 425 representing the screw in local object coordinate system 442. In certain other aspects, set of coordinates 425 representing the screw in local object coordinate system 442 may be transformed to coordinates that represent the screw in world coordinate system 440 (e.g., using pose 423 between local object coordinate system 442 and world coordinate system 440). This transformed set of coordinates may, in some cases, be displayed to the user.

In certain aspects, language model 330 is able to generate this output at least based on processing context 332. For example, without this information, language model 330 may be unable to produce output 432 and thereby provide a relevant, complete, and accurate response to first user input 402.

Output 432 generated by XR system 400 may include text output, audio output, video output (e.g., animation of how to remove the screw referenced in output 432) or haptic output. In certain aspects, XR system 400 may provide this output 432 (e.g., from language model 330), as is, to a user that provided first user input 402 to XR system 400.

In certain other aspects, other output based on output 432 may be provided to the user. For example, as shown in FIG. 4B, in certain aspects, XR system 400 may include a modification component 451 and an augmentation generation component 452. Modification component 451 may process output 432 and generate modified output 454. Modified output 454 may remove object state information (e.g. position information) for the first object (e.g., the screw) included in output 432 and, in some cases, replace this information with one or more other tokens. For example, as shown in FIG. 4B, the tokens “the screw at position <x1, y1, z1> in the local object coordinate system” included in output 432 may be removed and replaced with tokens “this screw” in modified output 454. Further, an augmentation generation component 452 may transform the set of coordinates 425 representing the screw in local object coordinate system 442 to coordinates that represent the screw in world coordinate system 440 (e.g., using pose 423 between local object coordinate system 442 and world coordinate system 440). Augmentation generation component 452 may then generate digital content 456 based on the transformed coordinates of the screw (e.g., representing the screw in the world coordinate system). For example, augmentation generation component 452 may generate a pointer associated with the set of coordinates representing the screw in the world coordinate system 440, such that the pointer is associated with the position of the screw in the world coordinate system 440.

A display component 458 may display, such as on a user interface of an XR device 460, output 462 that includes the modified output 454 and the digital content 456. In certain aspects, the digital content 456 may be displayed, via the user interface, such that the digital content 456 overlays the screw in the scene, when viewed by the user using XR device 460. This digital content 456 may provide context to the language “this screw” included in modified output 454, thereby enabling a user of XR device 460 to determine that “this screw” included in modified output 454 is referring to the highlighted screw in the scene (e.g., highlighted via the digital content 456).

Although FIGS. 4A and 4B describe an example XR system 400 configured to perform output 432 generation based on first user input 402 and second user input 408, in some other examples, XR system 400 may be configured to generate output 432 based only on first user input 402 (e.g., generate output 432 without second user input 408). For example, XR system 400 may use language model 330 to process both first user input 402 and context 332 to generate output 432. As an illustrative example, first user input 402 may include a query from a user asking “I want to begin disassembly of the robot arm. Thus, where is the screw on the robot arm so that I can begin the disassembly?” The user may provide this first user input 402 to XR system 400 without also providing second user input 408 (e.g. without pointing to the screw, without gazing at the screw, etc.) and/or without XR system 400 obtaining second user input 408 (e.g., irrespective of whether the user is looking at the screw, pointing to the screw, etc.). In order to respond to the user's query, language model 330 may process first user input and context 332. In this example, output 432 generated by language model 330 may include information about a location of the screw on the robot arm.

### Example AI System

Certain aspects described herein may be implemented, at least in part, using some form of AI, e.g., the process of using an ML model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as an object detection system in autonomous driving.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

### Example AI System for Context Generation and Output Generation Related to Unknown Objects in an XR Environment

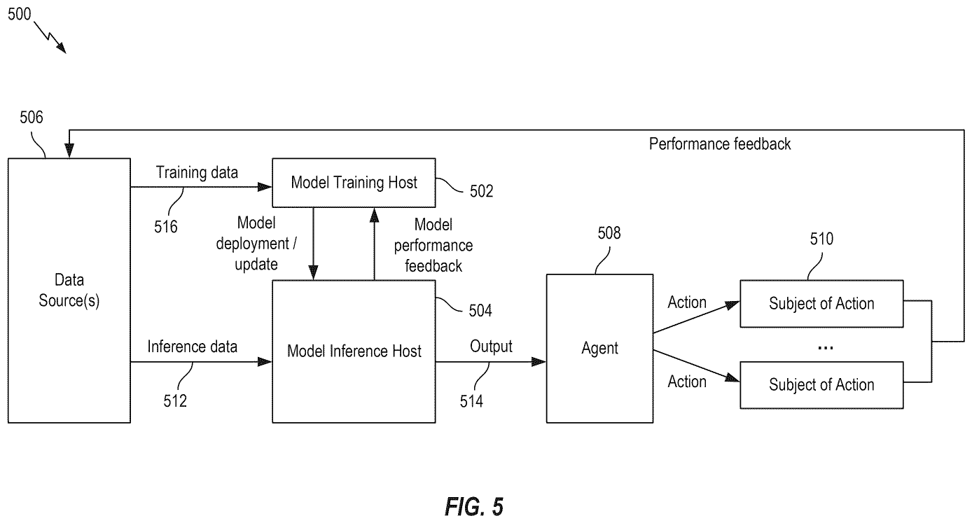

FIG. 5 is a diagram illustrating an example AI architecture 500 that may be used to implement the ML model(s), context generation techniques, and output generation techniques described in this disclosure. As illustrated, the architecture 500 includes multiple logical entities, such as a model training host 502 for training the ML model(s) for context and output generation (e.g., related to unknown objects in XR), a model inference host 504 for running inference using the trained ML Model(s) for context and output generation and/or other downstream computer vision task(s), data source(s) 506 providing training and inference data, and an agent 508 that utilizes the model(s)' output. This AI architecture could be used to enable the disclosed context and output generation techniques in various ML applications, such as in XR applications.

The model inference host 504, in the architecture 500, is configured to run the trained ML model(s) based on inference data 512 provided by data source(s) 506. The model inference host 504 may produce an output 514 (e.g., detected objects, scene representations) based on the inference data 512, which is then provided as input to the agent 508.

The agent 508 may be an element or entity that utilizes the output of the ML model(s) hosted by the model inference host 504. The agent 508 could be a software component, a hardware accelerator, or a system that leverages output related to unknown objects in an XR environment.

For example, if the output 514 from the model inference host 504 includes masks for various objects in a scene, the agent 508 may be an object detection module and/or a motion planning module that generates safe and efficient trajectories for a robot. That is, in robotics, segmentation mask(s), such as output by the ML model(s) described herein, may be used to enable a robot to discern and navigate around objects in their environment.

After receiving the output 514 from the model inference host 504, the agent 508 may determine how to utilize it. For instance, if the agent 508 decides to use the output 514, it may apply it to the subject of the action 510, which represents the data being processed or enhanced. In some cases, the agent 508 and subject of action 510 may be tightly integrated.

The data sources 506 may be configured to collect data used as training data 516 for the model training host 502 to train the ML model(s). The data sources 506 may also provide inference data 512 to the model inference host 504. This data could come from various entities and may include the subject of action 510. For example, for training a model, the data sources 506 may collect synchronized sensor data from cameras, LiDAR, radar, and other sensors mounted on vehicles. The model training host 502 can then monitor the model(s)' performance on this data to determine if retraining or fine-tuning with the model is necessary to improve accuracy. In some cases, the agent 508 and the subject of action 510 are the same entity.

The data sources 506 may be configured for collecting data that is used as training data 516 for training the ML model(s). The data sources 506 may also provide inference data 512 (also referred to as input data) for feeding the trained model(s) during inference. In particular, the data sources 506 may collect data relevant to the context generation and/or output generation task at hand, such as user input having different modalities, sensor data from various modalities, or the like. This data may come from various sources, including the subject of action 510, which represents the data being processed by the model(s). The collected data is provided to the model training host 502 for training and fine-tuning the object detection model. For example, after the subject of action 510 (e.g., sensor data with known object positions) is processed by the model(s), the output 514 (e.g., detected objects and scene representations) may be compared to ground truth data to evaluate the model(s)' performance. If the output 514 is not sufficiently accurate, this performance feedback may be used by the model training host 502 to further train the model using the disclosed object detection techniques, aiming to improve detection accuracy and robustness. The updated model(s) may then be deployed to the model inference host 504.

In certain aspects, the model training host 502 may be deployed at or with the same or a different entity than that in which the model inference host 504 is deployed. For example, to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, the ML model(s) may be deployed at or on a computing device. In some other aspects, the ML model(s) are deployed at or on an embedded system or mobile device for enabling efficient on-device inference. More specifically, a model inference host, such as model inference host 504 in FIG. 5, may be deployed at or on the embedded system or mobile device for running the model(s) to generate output responding to user queries related to unknown object(s) in an XR environment, such as in real-time.

### Example AI Model

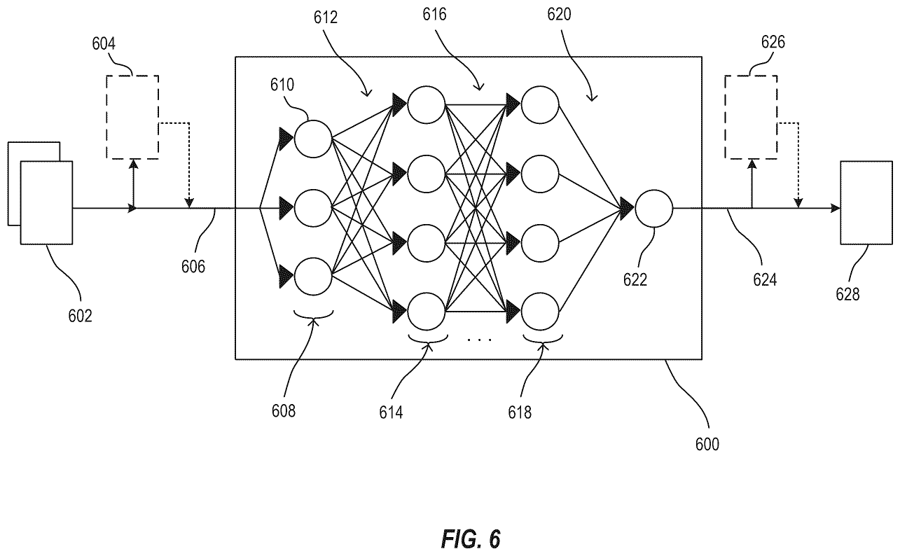

FIG. 6 is an illustrative block diagram of an example artificial neural network (ANN) 600 that can be used to implement the context generation and/or output generation techniques (e.g., associated with unknown objects in an XR environment) described in this disclosure.

ANN 600 may receive input data 606, which may include one or more bits of data 602, pre-processed data output from pre-processor 604 (optional), or some combination thereof. Here, data 602 may include sensor data from various modalities (e.g., cameras, LiDAR, radar), such as one or more frames, user prompt(s), simulated prompt(s), or the like, e.g., depending on the stage of development and/or deployment of ANN 600. Pre-processor 604 may, for example, process all or a portion of data 602 to synchronize sensor inputs, apply calibration parameters, or normalize the data. In some implementations, pre-processor 604 may add additional data to data 602, such as time stamps or sensor metadata.

ANN 600 includes at least one first layer 608 of artificial neurons 610 (e.g., perceptrons) to process input data 606 and provide resulting first layer output data via edges 612 to at least a portion of at least one second layer 614. Second layer 614 processes data received via edges 612 and provides second layer output data via edges 616 to at least a portion of at least one third layer 618. Third layer 618 processes data received via edges 616 and provides third layer output data via edges 620 to at least a portion of a final layer 622 including one or more neurons to provide output data 624. All or part of output data 624 may be further processed in some manner by (optional) post-processor 626. Thus, in certain examples, ANN 600 may provide output data 628 that is based on output data 624, post-processed data output from post-processor 626, or some combination thereof. Post-processor 626 may be included within ANN 600 in some other implementations. Post-processor 626 may, for example, process all or a portion of output data 624 which may result in output data 628 being different, at least in part, to output data 624, e.g., as result of data being changed, replaced, deleted, etc. In some implementations, post-processor 626 may be configured to add additional data to output data 624, such as domain-specific post-processing or adaptation. In this example, second layer 614 and third layer 618 represent intermediate or hidden layers that may be arranged in a hierarchical or other like structure. Although not explicitly shown, there may be one or more further intermediate layers between the second layer 614 and the third layer 618.

The structure and training of artificial neurons 610 in the various layers may be tailored to specific requirements of an application, such as multi-grid sensor fusion for object detection and tracking. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process to learn domain-invariant representations. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 412 in FIG. 5) across different domains. Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 600 and a number of layers and a number of artificial neurons in each layer, as well as selecting activation functions, a loss function, training processes, etc., to enable domain generalization and adaptation. Once an initial model has been designed, training of the model may be conducted using training data from multiple domains. Training data may include one or more datasets within which ANN 600 may detect, determine, identify or ascertain patterns that are consistent across domains. Training data may represent various types of information, including written, visual, audio, environmental context, operational properties, etc., from different domains. During training, parameters of artificial neurons 610 may be changed, such as to minimize or otherwise reduce a loss function or a cost function that measures the model's performance across domains. A training process may be repeated multiple times to fine-tune ANN 600 with each iteration to improve its domain generalization capability.

Various ANN model structures are available for consideration in the context of domain generalization and adaptation. For example, in a feedforward ANN structure each artificial neuron 610 in a layer receives information from the previous layer and likewise produces information for the next layer. In a convolutional ANN structure, some layers may be organized into filters that extract domain-invariant features from data (e.g., training data and/or input data). In a recurrent ANN structure, some layers may have connections that allow for processing of data across time, such as for processing information having a temporal structure, such as time series data forecasting across domains.

In an autoencoder ANN structure, compact representations of data may be processed and the model trained to predict or potentially reconstruct original data from a reduced set of features that capture domain-invariant patterns. An autoencoder ANN structure may be useful for tasks related to dimensionality reduction and data compression in a domain-agnostic manner.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models in a domain-adaptive way. For example, a GAN could be used to generate realistic training data for a new domain to improve the domain generalization of another model.

A transformer ANN structure makes use of attention mechanisms that may enable the model to process input sequences in a parallel and efficient manner while capturing long-range dependencies and domain-specific patterns. An attention mechanism allows the model to focus on different parts of the input sequence at different times based on their relevance to the task and domain. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences in a domain-adaptive way. The output of a transformer ANN structure may be obtained by applying a linear transformation to the output of a final attention layer. A transformer ANN structure may be of particular use for tasks that involve sequence modeling, or other like processing, across different domains.

Another example type of ANN structure, is a model with one or more invertible layers. Models of this type may be inverted or “unwrapped” to reveal the input data that was used to generate the output of a layer, which can be useful for understanding how the model adapts to different domains.

Other example types of ANN model structures that can be used for domain generalization and adaptation include fully connected neural networks (FCNNs) and long short-term memory (LSTM) networks.

ANN 600 or other ML models may be implemented in various types of processing circuits along with memory and applicable instructions therein, for example, as described herein with respect to FIG. 5. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models that can perform object detection.

### Example Methods for Context Generation and Output Generation Related to Unknown Objects in an XR Environment

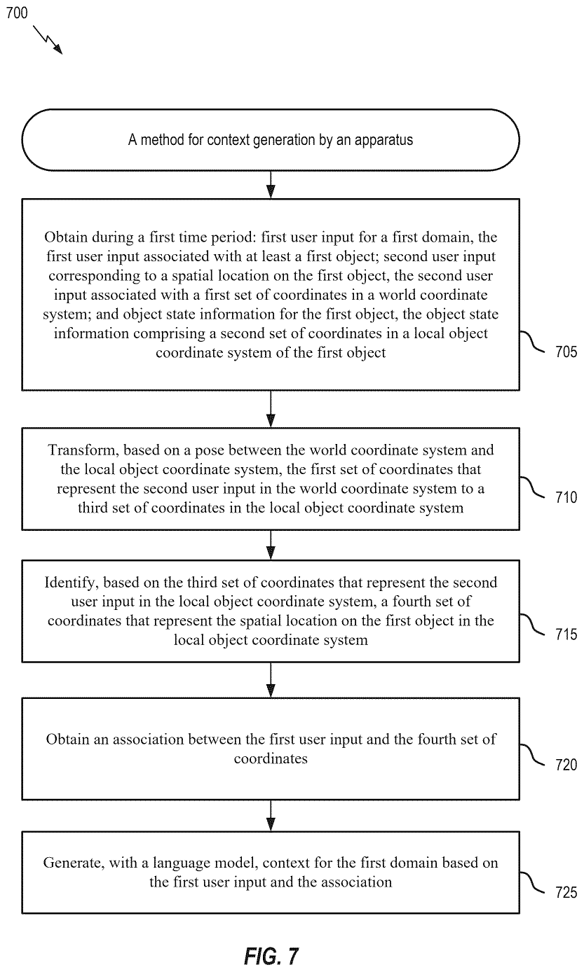

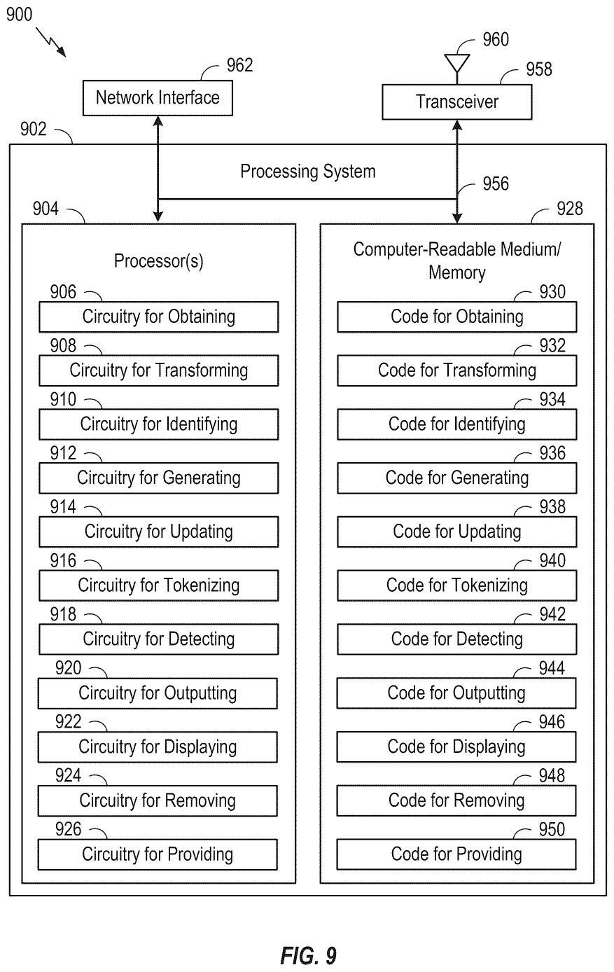

FIG. 7 depicts an example method 700 for context generation. In some aspects, method 700, or any aspect related to it, may be performed by an apparatus, such as apparatus 900 of FIG. 9, which includes various components operable, configured, or adapted to perform the method 700. Apparatus 900 is described below in further detail.

Method 700 begins at block 705 with obtaining during a first time period: first user input for a first domain, the first user input associated with at least a first object; second user input corresponding to a spatial location on the first object, the second user input associated with a first set of coordinates in a world coordinate system; and object state information for the first object, the object state information comprising a second set of coordinates in a local object coordinate system of the first object.

Method 700 then proceeds to block 710 with transforming, based on a pose between the world coordinate system and the local object coordinate system, the first set of coordinates that represent the second user input in the world coordinate system to a third set of coordinates in the local object coordinate system.

Method 700 then proceeds to block 715 with identifying, based on the third set of coordinates that represent the second user input in the local object coordinate system, a fourth set of coordinates that represent the spatial location on the first object in the local object coordinate system.

Method 700 then proceeds to block 720 with obtaining an association between the first user input and the fourth set of coordinates.

Method 700 then proceeds to block 725 with generating, with a language model, context for the first domain based on the first user input and the association.

In certain aspects, method 700 further includes updating a context window of the language model to include the context for the first domain.

In certain aspects, method 700 further includes generating, with the language model, an output based on a user query for the first domain and the context for the first domain.

In certain aspects, method 700 further includes tokenizing the first user input to obtain a set of tokens, wherein the association between the first user input and the fourth set of coordinates comprises an association between a first token of the set of tokens and the fourth set of coordinates that represent the spatial location on the first object in the local object coordinate system.

In certain aspects, the first token comprises a demonstrative pronoun or a demonstrative adjective in the first user input.

In certain aspects, the context comprises modified first user input; the modified first user input comprises a second token instead of the first token; and the second token is based on the fourth set of coordinates.

In certain aspects, the second user input comprises at least one of: hand movement of a user; eye movement of the user; eye gaze of the user; or movement of an XR controller by the user.

In certain aspects, the first user input comprises at least one of: text input, audio input, or one or more frames.

In certain aspects, the language model comprises an LLM.

Note that FIG. 7 is just one example of a method, and other methods including fewer, additional, or alternative operations are possible consistent with this disclosure.

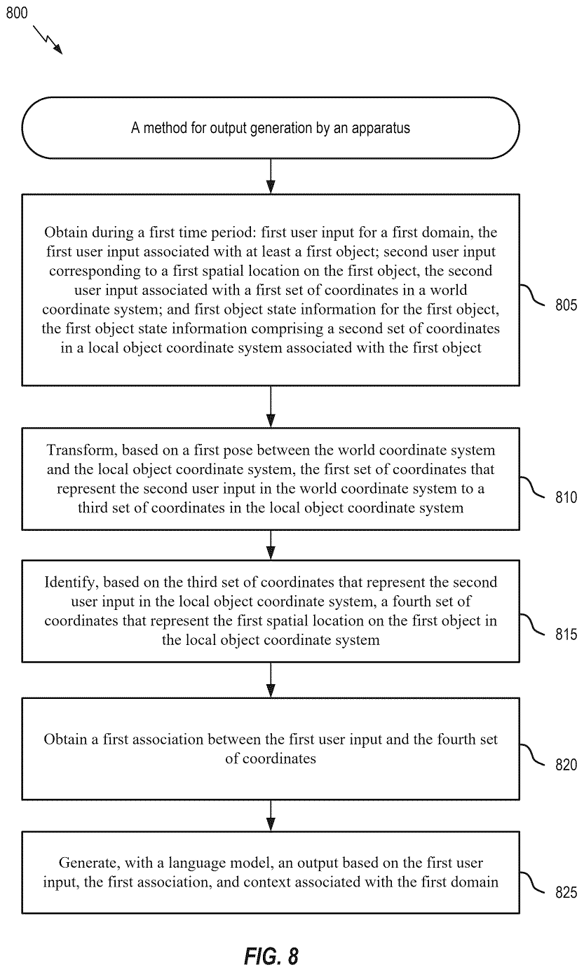

FIG. 8 depicts an example method 800 for output generation related to unknown objects in an XR environment. In some aspects, method 800, or any aspect related to it, may be performed by an apparatus, such as apparatus 900 of FIG. 9, which includes various components operable, configured, or adapted to perform the method 800. Apparatus 900 is described below in further detail.

Method 800 begins at block 805 with obtaining during a first time period: first user input for a first domain, the first user input associated with at least a first object; second user input corresponding to a first spatial location on the first object, the second user input associated with a first set of coordinates in a world coordinate system; and first object state information for the first object, the first object state information comprising a second set of coordinates in a local object coordinate system associated with the first object.

Method 800 then proceeds to block 810 with transforming, based on a first pose between the world coordinate system and the local object coordinate system, the first set of coordinates that represent the second user input in the world coordinate system to a third set of coordinates in the local object coordinate system.

Method 800 then proceeds to block 815 with identifying, based on the third set of coordinates that represent the second user input in the local object coordinate system, a fourth set of coordinates that represent the first spatial location on the first object in the local object coordinate system.

Method 800 then proceeds to block 820 with obtaining a first association between the first user input and the fourth set of coordinates.

Method 800 then proceeds to block 825 with generating, with a language model, an output based on the first user input, the first association, and context associated with the first domain.

In certain aspects, the output comprises the fourth set of coordinates that correspond to the first spatial location on the first object in the local object coordinate system.

In certain aspects, method 800 further includes outputting digital content based on the fourth set of coordinates that represent the first spatial location on the first object in the local object coordinate system.

In certain aspects, outputting the digital content comprises displaying the digital content overlaid on the first object.

In certain aspects, method 800 further includes removing the fourth set of coordinates from the output to generate modified output; and providing the modified output in response to the first user input.

In certain aspects, the output comprises at least one of: text output; audio output; video output; or haptic output.

In certain aspects, the second user input comprises at least one of: hand movement of a user; eye movement of the user; eye gaze of the user; or movement of an XR controller by the user.

In certain aspects, the first user input comprises at least one of: text input, audio input, or one or more frames.

In certain aspects, method 800 further includes obtaining the context associated with the first domain from a context window of the language model.

In certain aspects, method 800 further includes obtaining during a second time period prior to the first time period: third user input for the first domain, the third user input associated with at least the first object; fourth user input corresponding to a second spatial location on the first object, the second user input associated with a fifth set of coordinates in the world coordinate system; and second object state information for the first object, the second object state information comprising a sixth set of coordinates in the local object coordinate system; transforming, based on a second pose between the world coordinate system and the local object coordinate system, the fifth set of coordinates that represent the fourth user input in the world coordinate system to a seventh set of coordinates in the local object coordinate system; identifying, based on the seventh set of coordinates that represent the second user input in the local object coordinate system, an eighth set of coordinates that represent the second spatial location on the first object in the local object coordinate system; obtaining a second association between the third user input and the eighth set of coordinates that represent the second spatial location on the first object in the local object coordinate system; and generating, with the language model, the context for the first domain based on the third user input and the second association.

In certain aspects, the language model comprises an LLM.

Note that FIG. 8 is just one example of a method, and other methods including fewer, additional, or alternative operations are possible consistent with this disclosure

### Example Apparatus

FIG. 9 depicts aspects of an example apparatus 900. In certain aspects, apparatus 900 is a computing device, a mobile device, and/or an edge device.

The apparatus 900 includes a processing system 902 coupled to a transceiver 958 (e.g., a transmitter and/or a receiver) and/or a network interface 962. The transceiver 958 is configured to transmit and receive signals for the apparatus 900 via an antenna 960, such as the various signals as described herein. The network interface 962 is configured to obtain and send signals for the apparatus 900 via communications link(s), such as a backhaul link, midhaul link, and/or fronthaul link as described herein. The processing system 902 may be configured to perform processing functions for the apparatus 900, including processing signals received and/or to be transmitted by the apparatus 900.

The processing system 902 includes one or more processors 904 and a computer-readable medium/memory 928. The one or more processors 904 are coupled to a computer-readable medium/memory 928 via a bus 956. The computer-readable medium/memory 928 is a non-transitory computer-readable medium/memory. In certain aspects, the computer-readable medium/memory 928 is configured to store instructions (e.g., computer-executable code), that when executed by the one or more processors 904, cause the one or more processors 904 to perform the method 700 described with respect to FIG. 7, or any aspect related to it, including any operations described in relation to FIG. 7; and the method 800 described with respect to FIG. 8, or any aspect related to it, including any operations described in relation to FIG. 8. Note that reference to a processor performing a function of apparatus 900 may include one or more processors performing that function of apparatus 900, such as in a distributed fashion.

In the depicted example, computer-readable medium/memory 928 stores code (e.g., executable instructions), including code for obtaining 930, code for transforming 932, code for identifying 934, code for generating 936, code for updating 938, code for tokenizing 940, code for detecting 942, code for outputting 944, code for displaying 946, code for removing 948, and code for providing 950. Processing of the code 930-950 may enable and cause the apparatus 900 to perform the method 700 described with respect to FIG. 7, or any aspect related to it; and the method 800 described with respect to FIG. 8, or any aspect related to it.

The one or more processors 904 include circuitry configured to implement (e.g., execute) the code stored in the computer-readable medium/memory 928, including circuitry for obtaining 906, circuitry for transforming 908, circuitry for identifying 910, circuitry for generating 912, circuitry for updating 914, circuitry for tokenizing 916, circuitry for detecting 918, circuitry for outputting 920, circuitry for displaying 922, circuitry for removing 924, and circuitry for providing 926. Processing with circuitry 906-926 may enable and cause the apparatus 900 to perform the method 700 described with respect to FIG. 7, or any aspect related to it; and the method 800 described with respect to FIG. 8, or any aspect related to it.

More generally, means for communicating, transmitting, sending or outputting for transmission may include transceiver 958 and/or antenna 960 of the apparatus 900 in FIG. 9, and/or one or more processors 904 of the apparatus 900 in FIG. 9. Means for communicating, receiving or obtaining may include transceiver 958 and/or antenna 960 of the apparatus 900 in FIG. 9, and/or one or more processors 904 of the apparatus 900 in FIG. 9

### EXAMPLE CLAUSES

Implementation examples are described in the following numbered clauses:

Clause 1: A method for context generation by an apparatus, comprising: obtaining during a first time period: first user input for a first domain, the first user input associated with at least a first object; second user input corresponding to a spatial location on the first object, the second user input associated with a first set of coordinates in a world coordinate system; and object state information for the first object, the object state information comprising a second set of coordinates in a local object coordinate system of the first object; transforming, based on a pose between the world coordinate system and the local object coordinate system, the first set of coordinates that represent the second user input in the world coordinate system to a third set of coordinates in the local object coordinate system; identifying, based on the third set of coordinates that represent the second user input in the local object coordinate system, a fourth set of coordinates that represent the spatial location on the first object in the local object coordinate system; obtaining an association between the first user input and the fourth set of coordinates; and generating, with a language model, context for the first domain based on the first user input and the association.

Clause 2: The method of Clause 1, further comprising updating a context window of the language model to include the context for the first domain.

Clause 3: The method of any one of Clauses 1-2, further comprising generating, with the language model, an output based on a user query for the first domain and the context for the first domain.

Clause 4: The method of any one of Clauses 1-3, further comprising: tokenizing the first user input to obtain a set of tokens, wherein the association between the first user input and the fourth set of coordinates comprises an association between a first token of the set of tokens and the fourth set of coordinates that represent the spatial location on the first object in the local object coordinate system.

Clause 5: The method of Clause 4, wherein the first token comprises a demonstrative pronoun or a demonstrative adjective in the first user input.

Clause 6: The method of any one of Clauses 4-5, wherein: the context comprises modified first user input; the modified first user input comprises a second token instead of the first token; and the second token is based on the fourth set of coordinates.

Clause 7: The method of any one of Clauses 1-6, wherein the second user input comprises at least one of: hand movement of a user; eye movement of the user; eye gaze of the user; or movement of an extended reality (XR) controller by the user.

Clause 8: The method of any one of Clauses 1-7, wherein the first user input comprises at least one of: text input, audio input, or one or more frames.

Clause 9: The method of any one of Clauses 1-8, wherein the language model comprises a large language model (LLM).

Clause 10: A method for output generation by an apparatus, comprising: obtaining during a first time period: first user input for a first domain, the first user input associated with at least a first object; second user input corresponding to a first spatial location on the first object, the second user input associated with a first set of coordinates in a world coordinate system; and first object state information for the first object, the first object state information comprising a second set of coordinates in a local object coordinate system associated with the first object; transforming, based on a first pose between the world coordinate system and the local object coordinate system, the first set of coordinates that represent the second user input in the world coordinate system to a third set of coordinates in the local object coordinate system; identifying, based on the third set of coordinates that represent the second user input in the local object coordinate system, a fourth set of coordinates that represent the first spatial location on the first object in the local object coordinate system; obtaining a first association between the first user input and the fourth set of coordinates; and generating, with a language model, an output based on the first user input, the first association, and context associated with the first domain.

Clause 11: The method of Clause 10, wherein the output comprises the fourth set of coordinates that correspond to the first spatial location on the first object in the local object coordinate system.

Clause 12: The method of Clause 11, further comprising: outputting digital content based on the fourth set of coordinates that represent the first spatial location on the first object in the local object coordinate system.

Clause 13: The method of Clause 12, wherein outputting the digital content comprises displaying the digital content overlaid on the first object.

Clause 14: The method of any one of Clauses 11-13, further comprising: removing the fourth set of coordinates from the output to generate modified output; and providing the modified output in response to the first user input.

Clause 15: The method of any one of Clauses 11-14, wherein the output comprises at least one of: text output; audio output; video output; or haptic output.

Clause 16: The method of any one of Clauses 10-15, wherein the second user input comprises at least one of: hand movement of a user; eye movement of the user; eye gaze of the user; or movement of an extended reality (XR) controller by the user.

Clause 17: The method of any one of Clauses 10-16, wherein the first user input comprises at least one of: text input, audio input, or one or more frames.

Clause 18: The method of any one of Clauses 10-17, further comprising obtaining the context associated with the first domain from a context window of the language model.

Clause 19: The method of Clause 18, further comprising: obtaining during a second time period prior to the first time period: third user input for the first domain, the third user input associated with at least the first object; fourth user input corresponding to a second spatial location on the first object, the second user input associated with a fifth set of coordinates in the world coordinate system; and second object state information for the first object, the second object state information comprising a sixth set of coordinates in the local object coordinate system; transforming, based on a second pose between the world coordinate system and the local object coordinate system, the fifth set of coordinates that represent the fourth user input in the world coordinate system to a seventh set of coordinates in the local object coordinate system; identifying, based on the seventh set of coordinates that represent the second user input in the local object coordinate system, an eighth set of coordinates that represent the second spatial location on the first object in the local object coordinate system; obtaining a second association between the third user input and the eighth set of coordinates that represent the second spatial location on the first object in the local object coordinate system; and generating, with the language model, the context for the first domain based on the third user input and the second association.

Clause 20: The method of any one of Clauses 10-19, wherein the language model comprises a large language model (LLM).

Clause 21: One or more apparatuses, comprising: one or more memories comprising executable instructions; and one or more processors configured to execute the executable instructions and cause the one or more apparatuses to perform a method in accordance with any one of Clauses 1-20.

Clause 22: One or more apparatuses configured for wireless communications, comprising: one or more memories; and one or more processors, coupled to the one or more memories, configured to cause the one or more apparatuses to perform a method in accordance with any one of Clauses 1-20.

Clause 23: One or more apparatuses configured for wireless communications, comprising: one or more memories; and one or more processors, coupled to the one or more memories, configured to perform a method in accordance with any one of Clauses 1-20.

Clause 24: One or more apparatuses, comprising means for performing a method in accordance with any one of Clauses 1-20.

Clause 25: One or more non-transitory computer-readable media comprising executable instructions that, when executed by one or more processors of one or more apparatuses, cause the one or more apparatuses to perform a method in accordance with any one of Clauses 1-20.

Clause 26: One or more computer program products embodied on one or more computer-readable storage media comprising code for performing a method in accordance with any one of Clauses 1-20.

Clause 27: One or more apparatuses configured for wireless communications, comprising: a processing system that includes one or more processors and one or more memories coupled with the one or more processors, the processing system configured to cause the one or more apparatuses to perform a method in accordance with any one of Clauses 1-20.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to cause the apparatus to:
obtain during a first time period:
first user input for a first domain, the first user input associated with at least a first object;
second user input corresponding to a spatial location on the first object, the second user input associated with a first set of coordinates in a world coordinate system; and
object state information for the first object, the object state information comprising a second set of coordinates in a local object coordinate system of the first object;
transform, based on a pose between the world coordinate system and the local object coordinate system, the first set of coordinates that represent the second user input in the world coordinate system to a third set of coordinates in the local object coordinate system;
identify, based on the third set of coordinates that represent the second user input in the local object coordinate system, a fourth set of coordinates that represent the spatial location on the first object in the local object coordinate system;
obtain an association between the first user input and the fourth set of coordinates; and
generate, with a language model, context for the first domain based on the first user input and the association.

2. The apparatus of claim 1, wherein the processing system is configured to cause the apparatus to update a context window of the language model to include the context for the first domain.

3. The apparatus of claim 1, wherein the processing system is configured to cause the apparatus to generate, with the language model, an output based on a user query for the first domain and the context for the first domain.

4. The apparatus of claim 1, wherein:
the processing system is configured to cause the apparatus to tokenize the first user input to obtain a set of tokens; and
the association between the first user input and the fourth set of coordinates comprises an association between a first token of the set of tokens and the fourth set of coordinates that represent the spatial location on the first object in the local object coordinate system.

5. The apparatus of claim 4, wherein the first token comprises a demonstrative pronoun or a demonstrative adjective in the first user input.

6. The apparatus of claim 4, wherein:
the context comprises modified first user input;
the modified first user input comprises a second token instead of the first token; and
the second token is based on the fourth set of coordinates.

7. The apparatus of claim 1, wherein the second user input comprises at least one of:
hand movement of a user;
eye movement of the user;
eye gaze of the user; or
movement of an extended reality (XR) controller by the user.

8. The apparatus of claim 1, wherein the first user input comprises at least one of:
text input,
audio input, or
one or more frames.

9. The apparatus of claim 1, wherein the language model comprises a large language model (LLM).

10. An apparatus comprising a processing system that includes one or more processors and one or more memories coupled with the one or more processors, the processing system configured to cause the apparatus to:
obtain during a first time period:
first user input for a first domain, the first user input associated with at least a first object;
second user input corresponding to a first spatial location on the first object, the second user input associated with a first set of coordinates in a world coordinate system; and
first object state information for the first object, the first object state information comprising a second set of coordinates in a local object coordinate system associated with the first object;
transform, based on a first pose between the world coordinate system and the local object coordinate system, the first set of coordinates that represent the second user input in the world coordinate system to a third set of coordinates in the local object coordinate system;
identify, based on the third set of coordinates that represent the second user input in the local object coordinate system, a fourth set of coordinates that represent the first spatial location on the first object in the local object coordinate system;
obtain a first association between the first user input and the fourth set of coordinates; and
generate, with a language model, an output based on the first user input, the first association, and context associated with the first domain.

11. The apparatus of claim 10, wherein the output comprises the fourth set of coordinates that correspond to the first spatial location on the first object in the local object coordinate system.

12. The apparatus of claim 11, wherein the processing system is configured to cause the apparatus to:
output digital content based on the fourth set of coordinates that represent the first spatial location on the first object in the local object coordinate system.

13. The apparatus of claim 12, wherein to cause the apparatus to output the digital content, the processing system is configured to cause the apparatus to:
display the digital content overlaid on the first object.

14. The apparatus of claim 11, wherein the processing system is configured to cause the apparatus to:
remove the fourth set of coordinates from the output to generate modified output; and
provide the modified output in response to the first user input.

15. The apparatus of claim 11, wherein the output comprises at least one of:
text output;
audio output;
video output; or
haptic output.

16. The apparatus of claim 10, wherein the second user input comprises at least one of:
hand movement of a user;
eye movement of the user;
eye gaze of the user; or
movement of an extended reality (XR) controller by the user.

17. The apparatus of claim 10, wherein the first user input comprises at least one of:
text input,
audio input, or
one or more frames.

18. The apparatus of claim 10, wherein the processing system is configured to cause the apparatus to obtain the context associated with the first domain from a context window of the language model.

19. The apparatus of claim 18, wherein the processing system is configured to cause the apparatus to:
obtain during a second time period prior to the first time period:
third user input for the first domain, the third user input associated with at least the first object;
fourth user input corresponding to a second spatial location on the first object, the second user input associated with a fifth set of coordinates in the world coordinate system; and
second object state information for the first object, the second object state information comprising a sixth set of coordinates in the local object coordinate system;
transform, based on a second pose between the world coordinate system and the local object coordinate system, the fifth set of coordinates that represent the fourth user input in the world coordinate system to a seventh set of coordinates in the local object coordinate system;
identify, based on the seventh set of coordinates that represent the second user input in the local object coordinate system, an eighth set of coordinates that represent the second spatial location on the first object in the local object coordinate system;
obtain a second association between the third user input and the eighth set of coordinates that represent the second spatial location on the first object in the local object coordinate system; and
generate, with the language model, the context for the first domain based on the third user input and the second association.

20. The apparatus of claim 10, wherein the language model comprises a large language model (LLM).
